(19) United States
(12) Patent Application Publication
(10) Pub. No.: US 2025/0308011 A1
(43) Pub. Date: Oct. 2, 2025

(54) MODEL GENERATION METHOD AND ABNORMALITY ESTIMATION SYSTEM

(71) Applicant: HONDA MOTOR CO., LTD., Tokyo (JP)

(72) Inventors: Osamu NOGARIYA, Saitama (JP); Tatsuya HATTORI, Saitama (JP)

(21) Appl. No.: 19/056,767

(22) Filed: Feb. 19, 2025

(30) Foreign Application Priority Data
Mar. 26, 2024 (JP) 2024-049745

(51) Int. Cl. G06T 7/00; G06N 20/00

(52) U.S. Cl. CPC G06T 7/0004; G06N 20/00; G06T 2207/10081; G06T 2207/20081; G06T 2207/30108

(57) ABSTRACT

An abnormality estimation system (1) includes: an input data reception unit (2) that receives X-ray CT image data (7D) of a test object (7) which is a battery laminate as input data; a teaching data storage unit (6) that stores the X-ray CT image data of a sample which is a battery laminate and abnormality data of the same sample as teaching data; a model generation unit (3) that generates an abnormality estimation model for a battery laminate by machine learning using the teaching data stored in the teaching data storage unit (6); a model estimation unit (4) that estimates an abnormality in the test object (7) from the input data received by the input data reception unit (2) using the abnormality estimation model generated by the model generation unit (3); and a display unit (5) that displays estimation results from the model estimation unit (4).

This application is based on and claims the benefit of priority from Japanese Patent Application No. 2024-049745, filed on 26 Mar. 2024, the content of which is incorporated herein by reference.

### BACKGROUND OF THE INVENTION

### Field of the Invention

The present invention relates to a model generation method and an abnormality estimation system. In more detail, the present invention relates to a model generation method for generating an abnormality estimation model for battery laminates, and an abnormality estimation system that estimates abnormalities in a battery laminate using this abnormality estimation model.

### Related Art

In recent years, the efforts directed towards the implementation of a low-carbon society or a decarbonized society have become more active, and research and development related to secondary batteries, particularly all-solid-state batteries, is being conducted for a reduction in CO2 emissions and improvements in energy efficiency also in vehicles.

Evaluating the material dispersion on a micron scale in the laminate structure and specific layers of an all solid-state battery is essential for raising battery performance and improving yield. For example, since the X-ray CT device described in Japanese Unexamined Patent Application, Publication No. 2020-187024 can non-destructively observe the internal structure of a test object, it is useful as a technique for evaluating the inside of an all solid-state battery.

Patent Document 1: Japanese Unexamined Patent Application, Publication No. 2020-187024

### SUMMARY OF THE INVENTION

However, X-ray images obtained by an X-ray CT device have low resolution compared to SEM images obtained by a scanning electron microscope (hereinafter the abbreviation “SEM” is used), and have limitations in the types of elements that can be analyzed thereby, and thus cannot precisely estimate abnormalities inside of an all solid-state battery.

In order to solve the above-mentioned problems, the present invention has an object of providing a model generation method that generates an abnormality estimation model which can estimate abnormalities in a test object which is a battery laminate based on X-ray image data, and an abnormality estimation system made using this abnormality estimation model, and consequently contributes to an improvement in energy efficiency.

A model generation method according to a first aspect of the present invention is a method for generating an abnormality estimation model with X-ray image data (for example, the X-ray CT image data 7D described later) of a test object (for example, the test object 7 described later) which is a battery laminate as an input, and abnormality data of the test object as an output, the method including: generating the abnormality estimation model by machine learning with X-ray image data of a sample (for example, the sample S described later) of the battery laminate and abnormality data of the sample as teaching data.

According to a second aspect of the present invention, in this case, it is preferable for the abnormality data of the sample to include information obtained by observing a cut surface (for example, the cut surface CS described later) of the sample after X-ray image data was obtained.

According to a third aspect of the present invention, in this case, it is preferable for the X-ray image data of the sample to include information obtained by irradiating X rays onto the sample which is fixed by a jig of column shape (for example, the jig 92 described later); and the abnormality data of the sample to include information obtained by cutting the sample by irradiating an ion beam (for example, the focused ion beam B described later) while fixing the sample to the jig, and then observing the cut surface.

According to a fourth aspect of the present invention, in this case, it is preferable for the abnormality data of the sample to include information obtained by alternately repeating cutting of the sample and observation of the cut surface.

An abnormality estimation system (for example, the abnormality estimation system 1 described later) according to a fifth aspect of the present invention includes: an input data receiver (for example, the input data reception unit 2 described later) that receives X-ray image data (for example, the X-ray CT image data 7D described later) of a test object (for example, the test object 7 described later) which is a battery laminate as input data; a model generator (for example, the model generation unit 3 described later) that generates an abnormality estimation model by machine learning with X-ray image data of a sample (for example, the sample S described later) which is the battery laminate and abnormality data of the sample as teaching data; and a model estimator (for example, the model estimation unit 4 described later) that estimates an abnormality in the test object from the input data using the abnormality estimation model.

An abnormality estimation system (for example, the abnormality estimation system 1 described later) according to a sixth aspect of the present invention includes: an input data receiver (for example, the input data reception unit 2 described later) that receives X-ray image data (for example, the X-ray CT image data 7D described later) of a test object (for example, the test object 7 described later) which is a battery laminate as input data; and a model estimator (for example, the model estimation unit 4 described later) that estimates an abnormality in the test object from the input data, using an abnormality estimation model generated by machine learning with X-ray image data of a sample (for example, the sample S described later) which is a battery laminate and abnormality data of the sample as teaching data.

According to the model generation method described in the first aspect of the present invention, the abnormality estimation model is generated by machine learning with X-ray image data of a sample which is a battery laminate and abnormality data of the same sample as the teaching data. When X-ray image data of a test object which is a battery laminate is inputted as the input data, it is thereby possible to generate an abnormality estimation model that estimates abnormalities in this test object. In addition, by utilizing the abnormality estimation model with the X-ray image data of the battery laminate as the input data in this way, since it is possible to estimate abnormalities in the test object non-destructively and quickly, it is possible to raise the battery performance and improve yield, which consequently contributes to an improvement in energy efficiency.

According to the model generation method as described in the second aspect of the present invention, by establishing the abnormality data including information obtained by observing the cut surface of the sample as the teaching data, it is possible to associate the X-ray image data of the test object and an abnormality which cannot be specified by just analyzing only this X-ray image data, by way of the abnormality estimation model. Consequently, according to the present invention, an abnormality estimation model of high abnormality estimation precision can be generated.

According to the model generation method as described in the third aspect of the present invention, the X-ray image data including information obtained by irradiating X rays onto the sample fixed to the jig of columnar shape, and the abnormality data including information obtained by cutting the sample by irradiating an ion beam while fixing this sample to the jig, and then further observing this cut surface are utilized as the teaching data. In other words, according to the present invention, since it is possible to align the coordinate position of the X-ray image data and the coordinate position of the abnormality data, an abnormality estimation model of high abnormality estimation precision can be generated.

According to the fourth aspect of the present invention, by alternately repeating cutting of the sample and observation of the cut surface, it is possible to obtain three-dimensional information of the inside of the sample. According to the model generation method of the present invention, by utilizing the abnormality data including such three-dimensional information as the teaching data, an abnormality estimation model of high abnormality estimation precision can be generated.

According to the abnormality estimation system as described in the fifth aspect of the present invention, the input data receiver receives X-ray image data of a test object which is a battery laminate as the input data; the model generator generates an abnormality estimation model by machine learning with X-ray image data of the sample and abnormality data as the teaching data; and the model estimator estimates an abnormality in the test object from input data received by the input data receiver, using the abnormality estimation model generated by the model generator. Consequently, according to the present invention, since it is possible to estimate abnormalities in the test object non-destructively and quickly, it is possible to raise the battery performance and improve yield, which consequently contributes to an improvement in energy efficiency.

According to the abnormality estimation system as described in the sixth aspect of the present invention, the input data receiver receives X-ray image data of a test object which is a battery laminate as the input data; and the model estimator estimates an abnormality in the test object based on the input data received by the input data receiver, using the abnormality estimation model generated by machine learning with the X-ray image data of the sample and the abnormality data as the teaching data. Consequently, according to the present invention, since it is possible to estimate abnormalities in the test object non-destructively and quickly, it is possible to raise the battery performance and improve yield, which consequently contributes to an improvement in energy efficiency.

### BRIEF DESCRIPTION OF THE DRAWINGS

FIG. 1 is a view showing the configuration of an abnormality estimation system according to an embodiment of the present invention;

FIG. 2A is a view showing a first display example of estimation results for abnormalities in a test object;

FIG. 2B is a view showing a second display example of estimation results for abnormalities in a test object;

FIG. 3 is a flowchart showing a specific sequence of a teaching data generation method;

FIG. 4A is a view schematically showing a sequence of preparing a sample of a battery laminate;

FIG. 4B is a view schematically showing the configuration of a sample holder;

FIG. 4C is a view schematically showing a sequence of a cutting process and an observation process;

FIG. 5 is a view comparing an X-ray CT image and an SEM image;

FIG. 6A is a view showing an example of an X-ray CT image of a battery laminate; and

FIG. 6B is a view showing an example of an SEM image of a battery laminate.

### DETAILED DESCRIPTION OF THE INVENTION

Hereinafter, a configuration of an abnormality estimation system for battery laminates, and a sequence of a generation method of an abnormality estimation model used in this abnormality estimation system according to the present invention will be described while referencing the drawings.

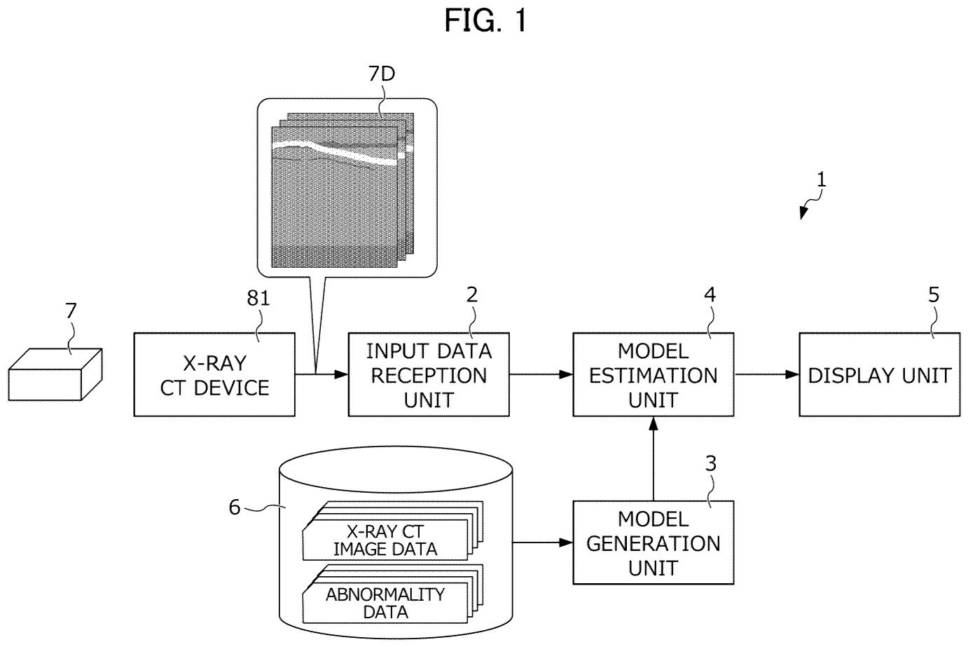

FIG. 1 is a view showing the configuration of an abnormality estimation system 1 according to the present embodiment. The abnormality estimation system 1 is a system which establishes a battery laminate for which the internal state thereof is known (more specifically, for example, an all solid-state battery or semi-solid state battery configured by laminating a negative electrode collector, a negative electrode layer, a solid electrolyte layer containing all solid or a semi-solid such as a gel, a positive electrode layer, a positive electrode collector, etc.) as a test object 7, and estimates abnormalities in this test object 7, based on X-ray image data of the test object 7 generated by an X-ray CT device 81.

The X-ray CT device 81 performs CT (Computed Tomography) imaging of the test object 7 using X rays. The X-ray CT device 81 includes: an X-ray source which irradiates X rays onto the test object 7, an X-ray detector arranged to sandwich and the test object 7 with this X-ray source and detects X rays passing through the test object 7, and an image processing computer which generates a tomographic image (hereinafter also referred to as “X-ray CT image data”) slicing a plane along the lamination direction of the test object 7 which is the battery laminate, by generating an X-ray image based on the X rays detected by the X-ray detector, and further conducting predetermined image processing on this X-ray image.

The abnormality estimation system 1 is a computer configured by hardware such as an arithmetic processing means such as a CPU, an auxiliary storage means such as a HDD or SSD storing various programs, a main storage means such as RAM for storing data which is necessitated temporarily upon the arithmetic processing means executing a program, and a display means which displays arithmetic processing results by the arithmetic processing means in a manner visibly recognizable by a user. In the abnormality estimation system 1, various functions are realized such as of an input data reception unit 2, a model generation unit 3, a model estimation unit 4, a display unit 5 and a teaching data storage unit 6 by way of such a hardware configuration.

The input data reception unit 2 receives X-ray CT image data 7D of the test object 7 generated by the X-ray CT device 81 as input data.

The model generation unit 3 reads a plurality of sets of teaching data stored in the teaching data storage unit 6, and generates an abnormality estimation model establishing the X-ray CT image data of the test object 7 as the input and the abnormality data of this test object 7 as the output, by performing machine learning on a neural network using this plurality of sets of teaching data. Herein, in the abnormality data outputted from the abnormality estimation model, information related to the shape and composition of abnormalities in the test object 7 as described later (more specifically, information related to the presence/absence of abnormalities such as cracks, voids, Li precipitate and foreign matter adhesion, as well as occurrence locations of these abnormalities and three-dimensional structure of abnormalities) is included.

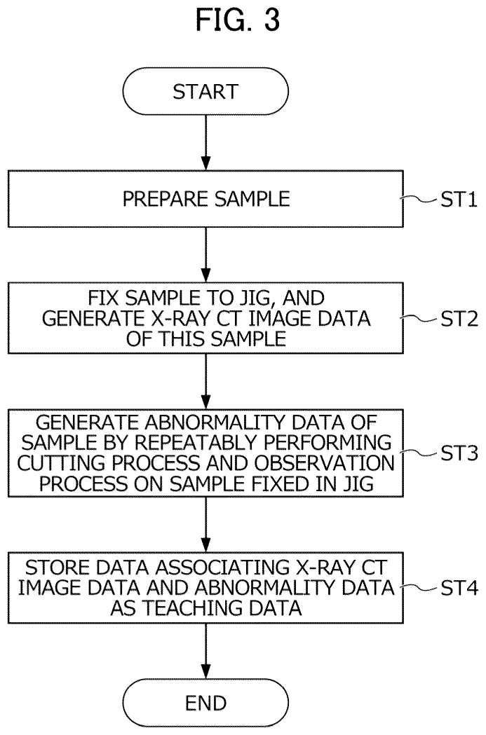

The teaching data storage unit 6 stores a plurality of sets of teaching data for use in machine learning by the model generation unit 3 as described above. As this teaching data, data generated for every one of the plurality of samples which are battery laminates prepared in advance, separately from the test object 7, can be used, as described later while referencing FIGS. 3 to 5 later. In addition, each piece of teaching data at least includes the X-ray CT image data of each sample, and the abnormality data of the same sample.

The model estimation unit 4 uses the abnormality estimation model generated by the aforementioned model generation unit 3 to estimate abnormalities in this test object 7 based on the input data of the test object 7 received by the input data reception unit 2. The model estimation unit 4, when inputting the input data received by the input data reception unit 2 to the abnormality estimation model, establishes the abnormality data outputted from this abnormality estimation model as the estimation results for abnormalities in the test object 7, and sends these to the display unit 5.

The display unit 5 displays the estimation results sent from the model estimation unit 4 in a manner which is visually recognizable by the operator.

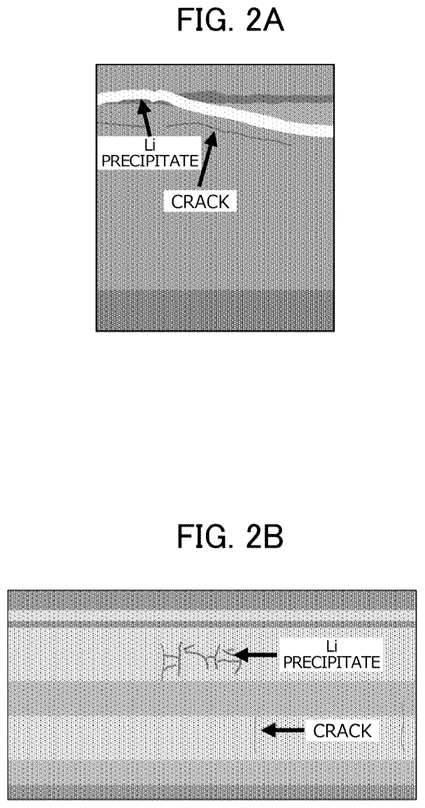

FIGS. 2A and 2B are views showing display examples of the estimation results for abnormalities in the test object 7. As shown in these FIGS. 2A and 2B, in the case of information related to the occurrence locations of abnormalities being included in the abnormality data, the display unit 5 may display in a highlighted manner the occurrence locations of abnormalities and the type of abnormality, together with the X-ray CT image of the test object 7 received by the input data reception unit 2. The operator can thereby easily confirm the occurrence locations of abnormalities inside of the test object 7 and the type of abnormality occurring, which cannot be confirmed by the naked eye. In addition, according to the present embodiment, by estimating abnormalities in the test object 7 from the X-ray CT image data 7D using the abnormality estimation model, the operator can confirm, without destroying the test object 7, the presence of abnormalities and the shape and/or composition thereof inside of the test object 7, which is difficult to specify just by analysis of only the X-ray CT image data 7D.

Next, a sequence of the generation method of teaching data which is necessitated for generating the above such abnormality estimation model for battery laminates will be described in detail while referencing FIGS. 3 to 5.

FIG. 3 is a flowchart showing a specific sequence of the teaching data generation method. More specifically, FIG. 3 shows a sequence of generating teaching data for one sample. In other words, a plurality of sets of teaching data which is necessitated for generating the abnormality estimation model by machine learning can be generated by repeatedly performing the teaching data generation method shown in FIG. 3 on different samples.

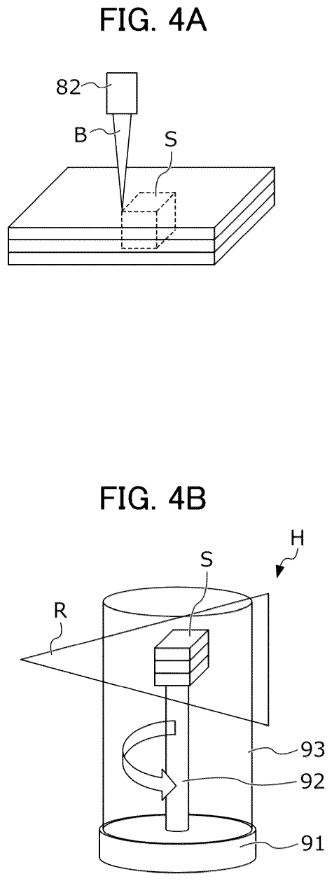

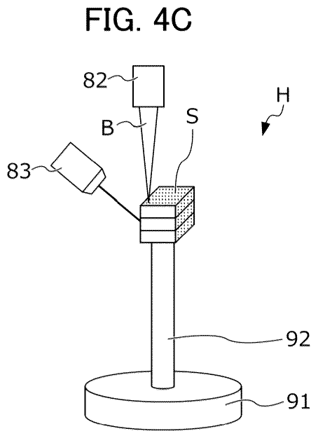

FIGS. 4A to 4C are views schematically illustrating the sequence of each step of the teaching data generation method.

First, in Step ST1, the operator prepares a sample of a battery laminate, and then advances to Step ST2.

FIG. 4A is a view schematically showing a sequence of preparing the sample of the battery laminate in Step ST1. In this Step ST1, by using an FIB device 82, for example, the operator irradiates a focused ion beam B along the lamination direction onto the battery laminate of sheet shape as shown in FIG. 4A, and cuts off a part of this battery laminate as a sample S for generating the teaching data described later. As described later in detail, it is preferable to cut off the sample S from the battery laminate, so that a side length is on the order of several tens of micrometers to several centimeters, so as to be able to observe the sample S by at least both the X-ray CT device and a scanning electron microscope, while fixing the position of the sample S with a jig described later.

Next, in Step ST2, the operator sets the sample S prepared in Step ST1 in a sample holder 9, generates the X-ray CT image data of the sample S using the X-ray CT device, and then advances to Step ST3.

FIG. 4B is a view schematically showing the configuration of the sample holder 9. The sample holder 9 includes: a base 91, a columnar jig 92 provided to this base 91, and a non-exposure sealed body 93 which covers the jig 92 and the sample S fixed to this jig 92. A plurality of needle-shaped members are provided at a leading end of the jig 92, and the bottom of the sample S is fixed to this needle-shaped member surface. More specifically, the bottom of the sample S, for example, is adhered to the needle-shaped member surface by deposition film formed using the FIB device 82.

In Step ST2, the operator fixes the sample S to the leading end of the jig 92 as shown in FIG. 4B. In addition, in Step ST2, the operator irradiates X rays R onto the sample S fixed to the jig 92 using the X-ray CT device 81 such as that shown in FIG. 1, for example, to generate X-ray CT image data of the sample S. More specifically, the X-ray CT image data of the sample S is generated by continuously X-ray CT imaging the sample S, while moving the X-ray source and X-ray detector of the X-ray CT device 81 along the circumference defined in a plane orthogonal to the jig 92 centered around the sample S, as shown by the arrow in FIG. 4B.

Next, in Step ST3, the operator generates abnormality data of the sample S, by alternately repeatedly performing at least once, more preferably several times, a cutting process using the FIB device 82 on the sample S fixed to the jig 92, and an observation process on the cut surface of the sample S using the observation device 83.

FIG. 4C is a view schematically showing a sequence of the cutting process and the observation process in Step ST3. In this cutting process in Step ST3, the operator irradiates a focused ion beam B along a cut surface determined in advance onto the sample S as shown in FIG. 4C, using the FIB device 82, thereby cutting the sample S. The cut surface of the sample S is determined so as to be parallel to the lamination direction of the sample S, such that the laminate structure inside of the sample S, which is a battery laminate, is exposed. In addition, in the present embodiment, a case of determining the positions of a plurality of cut surfaces of the sample S in advance such that the intervals along a direction perpendicular to the cut surface are equal intervals, as shown schematically by broken lines in FIG. 4C is described; however, the present invention is not limited thereto. The positions of the plurality of cut surfaces of the sample S may be determined manually or mechanically based on the X-ray CT image data of the sample S acquired in Step ST2, so as to include locations at which some kind of abnormality is expected to exist in the sample S.

In addition, in the observation process of Step ST3, the operator generates abnormality data of the sample S by observing, using the observation device 83, the cut surface of the sample S exposed in the above cutting process. In the present embodiment, a case is described in which the observation device 83 is established by combining: a scanning electron microscope (SEM) which observes a magnified image of the cut surface using an electron beam; an energy dispersive X-ray spectroscope (Energy Dispersive X-ray Spectroscopy: EDS) which performs elemental analysis of the cut surface by detecting characteristic X rays generated from the cut surface irradiated by the electron beam; and a time-of-flight secondary ion mass spectrometer (Time-of-Flight Secondary Ion Mass Spectrometry: TOF-SIMS) which performs analysis of elements and molecules on the cut surface by detecting the secondary ions generated when irradiating pulsed ions onto the cut surface. However, the present invention is not limited thereto. In addition to these devices, analysis of the chemical bonding state and crystalline structure of the cut surface may be performed using a Raman spectrometer, analysis of the crystalline structure may be performed using an electron backscatter diffractometer, or analysis of elements and the chemical bonding state may be performed using a soft X-ray diffractometer.

In Step ST3, the operator acquires an SEM image of the cut surface of the sample S and elementary information of the same cut surface using such an observation device 83, and generates the abnormality data of the cut surface by manually or mechanically analyzing this SEM image and elementary information.

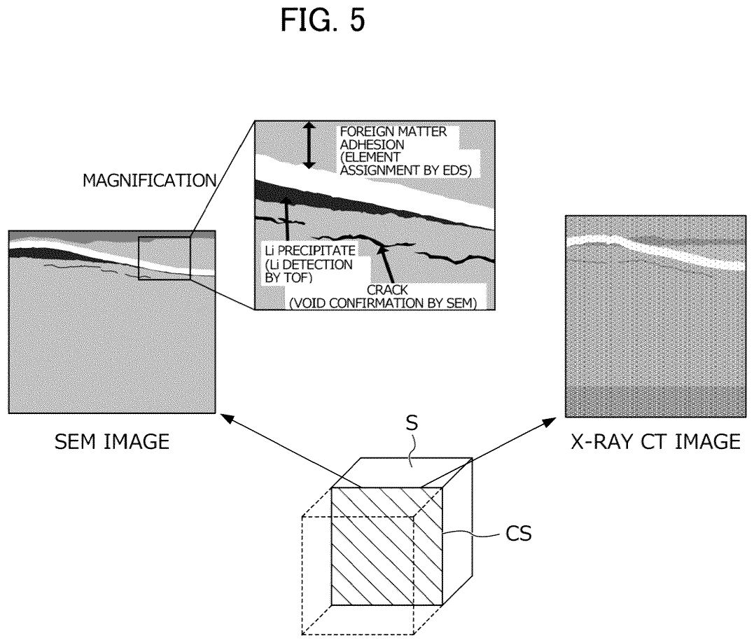

FIG. 5 is a diagram comparing the X-ray CT image acquired in Step ST2, and the SEM image acquired in Step ST3. FIG. 5 shows a schematic diagram of the SEM image of a predetermined cut surface CS of the sample S on the left side, and shows a schematic diagram of the X-ray CT image of the same cut surface on the right side.

Using the X-ray CT device, it is possible to acquire an image of a cross section of the inside of the sample S without destroying it. In contrast, in the case of using a scanning electron microscope, although it is necessary to destroy a part of the sample S to expose the cut surface CS of the inside thereof, it is possible to acquire a higher detail image of the cut surface CS than the X-ray CT image as shown in FIG. 5. By analyzing the SEM image in Step ST3 in this way, it is possible to confirm that cracks (i.e. voids) exist at a position which cannot be identified with sufficient accuracy with just the X-ray CT image. In addition, for example, by analyzing the elementary information obtained using EDS and/or TOF-SIMS in Step ST3, it is possible to confirm that elements which cannot be identified with just the X-ray CT image are adhering as foreign matter, or confirm that Li precipitation is occurring at a position which cannot be identified with just the X-ray CT image.

In Step ST3, by repeatedly performing the above such cutting process and observation process alternately over a plurality of times, the operator generates, as the abnormality data of the sample S, information such as the presence of abnormalities such as cracks, voids, Li precipitate and foreign matter adherence, as well as the occurrence location of these abnormalities and 3D structure of abnormalities, which cannot be easily specified just by analyzing only the X-ray CT image.

It should be noted that, in this Step ST3, the operator preferably repeatedly performs the above such cutting process and observation process, while the sample S is fixed to the jig 92 after acquiring the X-ray CT image data, i.e. without moving the position of the sample S relative to the jig 92 from the time of acquiring the X-ray CT image data. It is thereby possible to align the coordinate position of X-ray CT image data of the sample S, and the coordinate position of the abnormality data of the sample S. In addition, by repeatedly performing the cutting process and observation process alternately over a plurality of times in this way, it is possible to generate abnormality data including three-dimensional information of the inside of the sample S.

Referring back to FIG. 3, in Step ST4, the operator causes data associating the X-ray CT image data of the sample S generated in Step ST2 with the abnormality data of the sample S generated in Step ST3 to be stored in the teaching data storage unit 6 as a group of teaching data.

Although it is possible to specify the location at which some abnormality occurs, the rough shape of the abnormality, etc. just by analyzing only the X-ray CT image data in the aforementioned way, it is not possible to concretely specify what kind of abnormality is occurring. However, the contrast in the X-ray CT image of the battery laminate is believed to have a correlation with the specific content of the abnormality. In other words, there is believed to be a correlation between the X-ray CT image data of the sample S and the abnormality data of the same sample S. Therefore, by performing machine learning with the X-ray CT image data and abnormality data having such a correlation as the teaching data with the model generation unit 3, it is possible to generate an abnormality estimation model of the battery laminate.

According to the model generation method and abnormality estimation system 1 according to the present embodiment, the following effects are exerted.
(1) According to the model generation method related to the present embodiment, an abnormality estimation model is generated by machine learning with the X-ray CT image data of the sample S, which is a battery laminate, and the abnormality data of the same sample S, as the teaching data. It is thereby possible to generate an abnormality estimation model that, when inputting the X-ray CT image data 7D of the test object 7 which is a battery laminate as the input data, estimates abnormalities in this test object 7. In addition, by utilizing the abnormality estimation model establishing the X-ray CT image data 7D of the battery laminate as the input data in this way, since it is possible to estimate abnormalities in the test object 7 non-destructively and quickly, it is possible to raise the battery performance and improve yield, which consequently contributes to an improvement in energy efficiency.
(2) According to the model generation method related to the present embodiment, by establishing the abnormality data including information obtained by observing the cut surface CS of the sample S as the teaching data, it is possible to associate the X-ray CT image data 7D of the test object 7 and an abnormality which cannot be specified by just analyzing only this X-ray CT image data, by way of the abnormality estimation model. Consequently, according to the present embodiment, an abnormality estimation model of high abnormality estimation precision can be generated.

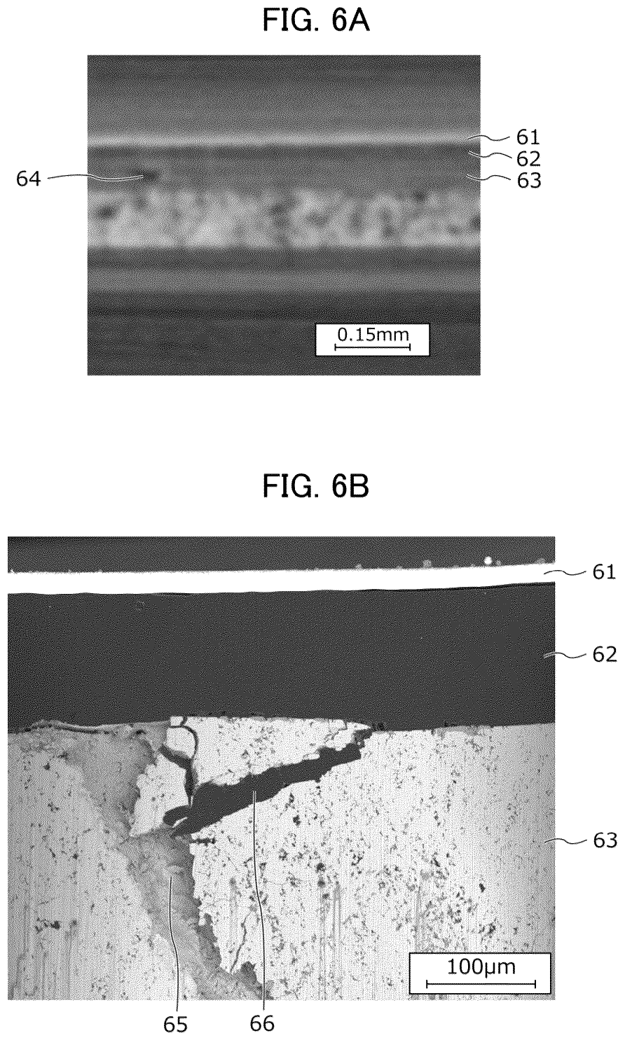

FIG. 6A is a view showing an example of an X-ray CT image of a battery laminate, and FIG. 6B is a view showing an example of an SEM image of a battery laminate. FIGS. 6A and 6B both show portions including a Cu collector foil 61, Li layer 62 and solid electrolyte layer 63 in a battery laminate.

As shown in FIG. 6A, in the X-ray CT image, it is possible to confirm an abnormality which exhibits darker contrast than the surroundings within the solid electrolyte layer 63 as indicated by reference symbol 64. It can be inferred that this portion indicated by reference symbol 64 is lower density than the solid electrolyte layer of the surroundings; however, it is not possible to distinguish from only the X-ray CT image shown in FIG. 6A whether being a void or Li precipitate. In contrast, as shown in FIG. 6B, since SEM images are clearer than X-ray CT images, and thus unevenness along the depth direction of a cross section can also be confirmed, not only the existence of abnormalities in the portions indicated by reference symbols 65 and 66, but also the specific contents thereof can be distinguished. In other words, in the example shown in FIG. 6B, since it possible to confirm unevenness along the depth direction in the portion indicated by the reference symbol 65, it is possible to distinguish the abnormality indicated at this reference symbol 65 as being a crack. In addition, the abnormality at the portion indicated by reference symbol 66 can be distinguished as being Li precipitate. In this way, with the model generation method according to the present embodiment, by observing the cut surface CS of the sample S using a scanning electron microscope, and further generating the abnormality data based on an SEM image obtained from this, it is possible to associate the X-ray CT image data 7D of the test object 7 and an abnormality which cannot be easily specified just by analyzing only this X-ray CT image data, by way of the abnormality estimation model.
(3) According to the model generation method related to the present embodiment, the X-ray image data including information obtained by irradiating X rays onto the sample S fixed in the columnar jig 92, and the abnormality data including information obtained by cutting the sample S by irradiating a focused ion beam B while fixing this sample S in the jig 92, and then further observing this cut surface CS are utilized as the teaching data. In other words, according to the present embodiment, it is possible to align the coordinate position of the X-ray CT image data and the coordinate position of the abnormality data; therefore, an abnormality estimation model of high abnormality estimation precision can be generated.
(4) By alternately repeating the cutting of the sample and observation of the cut surface, it is possible to obtain three-dimensional information of the inside of the sample. According to the model generation method related to the present embodiment, by utilizing the abnormality data including such three-dimensional information, an abnormality estimation model of high abnormality estimation precision can be generated.
(5) According to the abnormality estimation system 1 related to the present embodiment, the input data reception unit 2 receives the X-ray CT image data of the test object 7 which is a battery laminate as the input data, the model generation unit 3 generates an abnormality estimation model by machine learning with the X-ray CT image data of the sample S and the abnormality data as the teaching data, and the model estimation unit 4 estimates abnormalities in the test object 7 from the input data received by the input data reception unit 2 using the abnormality estimation model generated by the model generation unit 3. Consequently, according to the present embodiment, since it is possible to estimate an abnormality in the test object 7 non-destructively and quickly, it is possible to raise the battery performance and improve yield, which consequently contributes to an improvement in energy efficiency.
(6) According to the abnormality estimation system 1 related to the present embodiment, the input data reception unit 2 receives the X-ray CT image data of the test object 7 which is a battery laminate, and the model estimation unit 4 estimates abnormalities in the test object 7 from the input data received by the input reception unit 2, using the abnormality estimation model generated by machine learning with the X-ray CT image data of the sample S and the abnormality data as the teaching data. Consequently, according to the present embodiment, since it is possible to estimate abnormalities in the test object 7 non-destructively and quickly, it is possible to raise the battery performance and improve yield, which consequently contributes to an improvement in energy efficiency.

Although embodiments of the present invention have been described above, the present invention is not to be limited thereto. The configurations of detailed parts thereof may be modified where appropriate within the scope of the gist of the present invention.

What is claimed is:

1. A model generation method for generating an abnormality estimation model with X-ray image data of a test object which is a battery laminate as an input, and abnormality data of the test object as an output, the model generation method comprising:
generating the abnormality estimation model by machine learning with X-ray image data of a sample of the battery laminate and abnormality data of the sample as teaching data.

2. The model generation method according to claim 1, wherein the abnormality data of the sample includes information obtained by observing a cut surface of the sample after X-ray image data was obtained.

3. The model generation method according to claim 2, wherein the X-ray image data of the sample includes information obtained by irradiating X rays onto the sample which is fixed by a jig of column shape, and
wherein the abnormality data of the sample includes information obtained by cutting the sample by irradiating an ion beam while fixing the sample to the jig, and then observing the cut surface.

4. The model generation method according to claim 3, wherein internal abnormality information of the sample includes information obtained by alternately repeating cutting of the sample and observation of the cut surface.

5. An abnormality estimation system comprising:
an input data receiver that receives X-ray image data of a test object which is a battery laminate as input data;
a model generator that generates an abnormality estimation model by machine learning with X-ray image data of a sample which is a battery laminate and abnormality data of the sample as teaching data; and
a model estimator that estimates an abnormality in the test object from the input data using the abnormality estimation model.

6. An abnormality estimation system comprising:
an input data receiver that receives X-ray image data of a test object which is a battery laminate as input data; and
a model estimator that estimates an abnormality in the test object based on the input data, using an abnormality estimation model generated by machine learning with X-ray image data of a sample which is a battery laminate and abnormality data of the sample as teaching data.
